(19) United States
(12) Patent Application Publication
(10) Pub. No.: US 2014/0373048 A1
(43) Pub. Date: Dec. 18, 2014

(54) REAL-TIME TOPIC-RELEVANT TARGETED ADVERTISING LINKED TO MEDIA EXPERIENCES

(71) Applicants: Stanley Mo, Portland, OR (US); Victor Szilagyi, London (GB); Claudio J. Ochoa, Villa Allende (AR); Shannon R. Schroeder, Hillsboro, OR (US)

(72) Inventors: Stanley Mo, Portland, OR (US); Victor Szilagyi, London (GB); Claudio J. Ochoa, Villa Allende (AR); Shannon R. Schroeder, Hillsboro, OR (US)

(21) Appl. No.: 13/995,995

(22) PCT Filed: Dec. 28, 2011
(86) PCT No.: PCT/US11/67484

§ 371 Date: Aug. 28, 2014

(51) Int. Cl. H04N 21/81; H04N 21/234

(52) U.S. Cl. CPC H04N 21/812; H04N 21/23424
USPC 725/34

(57) ABSTRACT

Methods and systems may involve receiving a real-time keyword associated with media content, and identifying modifier data associated with a user that encounters the media content. In addition, the real-time keyword and the modifier data may be transmitted to an advertising service, which may select a topic-relevant and user-specific advertisement based on the real-time keyword and the modifier data.

### BACKGROUND

Traditional advertising solutions may involve the presentation of advertisements to large audiences during commercial break periods that occur between periods of programming content. Such solutions may be unable to advertise products and/or services concurrently with the presentation of the actual programming content, and may therefore fail to fully encourage certain consumer purchasing activity. While sonic attempts may have been made at “fingerprinting” (e.g., embedding) advertising information into programming content, such an approach may be associated with significant post-production costs, may be difficult to scale to widespread use, and may lack the ability to achieve platform-specific customization. Moreover, conventional advertisement fingerprinting techniques may be unsuitable for certain types of programming such as live programming.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of an advertising architecture according to an embodiment;

FIG. 2 is a flowchart of an example of a method of operating a device according to an embodiment;

FIG. 3 is a flowchart of an example of a method of operating an advertising service according to an embodiment; and

FIG. 4 is a block diagram of an example of a device according to an embodiment.

### DETAILED DESCRIPTION

Embodiments may include at least one computer accessible storage medium having a set of instructions which, if executed by a processor, cause a computer to receive a real-time keyword associated with media content. The instructions may also cause a computer to identify modifier data associated with a user that encounters the media content, and transmit the real-time keyword and the modifier data to an advertising service.

Embodiments may also include a device having a payload module to identify modifier data associated with a user that encounters media content. The device may also have a communications interface to receive a real-time keyword associated with the media content, and transmit the real-time keyword and the modifier data to an advertising service.

Other embodiments may include at least one computer accessible storage medium having a set of instructions which, if executed by a processor, cause a computer to receive a payload communication from a device. The payload communication may include a real-time keyword associated with media content, and modifier data associated with a user that encounters the media content. The instructions may also cause a computer to select an advertisement based on the real-time keyword and the modifier data, and transmit the advertisement to the device.

In addition, embodiments may involve a computer implemented. method in which a real-time keyword associated with media content is received. The real-time keyword may include one or more of closed. captioned information, subtitle information and dubbing information. The method may also provide for identifying a user that encounters the media content based on one or more of login information, device information, web service selection information, and the media content. Additionally, modifier data associated with the user may be identified, wherein the modifier data includes one or more of social network information, location information, time information, contact information, and preference information. The method may also provide for transmitting the real-time keyword and the modifier data to an advertising service, and receiving an advertisement from the advertisement service.

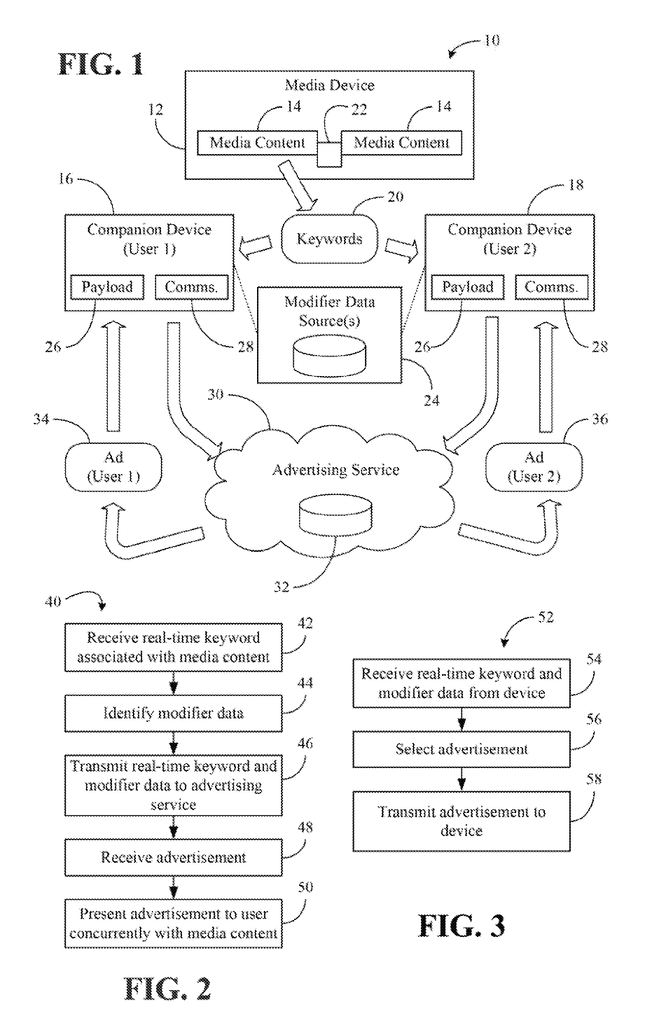

Turning now to FIG. 1, an advertising architecture 10 is shown. In the illustrated example, a media device 12 presents media content 14 to users of companion devices 16, 18. The media device 12 may include, for example, a smart television (TV), display (e.g., liquid crystal display/LCD, cathode ray tube/CRT monitor, plasma display, etc.), personal digital assistant (PDA), media player, imaging device, mobile Internet device (MID), any smart device such as a smart phone, smart tablet, and so forth, or any combination thereof. In addition, the media device 12 may be part of a notebook computer, personal computer (PC), server, workstation, etc. The companion devices 16, 18, may also include a wide variety of devices such as, for example, smart tablets, PDAs, wireless smart phones, media players, imaging devices, and/or MIDs.

During presentation of the media content 14 to the users of the companion devices 16, 18 one or more real-time keywords 20 may be extracted from the media content 14, wherein the real-time keywords 20 include information such as, for example, closed captioned (CC) information, subtitle information., dubbing information, and so forth. Of particular note is that the illustrated keywords 20 are obtained from the media content 14 itself, rather than from one or more TV advertisement inserts 22 that may occur during a commercial break period between periods of the media content 14. In one example, the media content 14 includes live programming such as, for example, sporting event, news, online and/or radio broadcast programming that may not be readily susceptible to conventional advertisement fingerprinting techniques.

In the illustrated example, the real-time keywords 20 are sent (e.g., via wired or wireless connection) to the companion devices 16, 18, which each have access to one or more modifier data sources 24. Generally, each companion device 16, 18, may be equipped with a communications interface 28 that receives the real-time keywords 20 and provides the real-time keywords 20 to a payload module 26 that builds a user-specific and topic-relevant payload to communication. For example, the payload module 26 of a first companion device 16 may have an identification module (not shown) that identifies the user (e.g., Dad) of the first companion device 16 based on login information (e.g. user identifier, password, biometrics), device information (e.g., serial number, media access control/MAC address, Internet protocol/IP address), web service selection information (e.g., web service selections made by the user), the media content 14 (e.g., the user's favorite shows), and so forth. Similarly, the payload module 26 of a second companion device 18 may have an identification module that identifies the user (e.g., teenage daughter) of the second companion device 18.

The illustrated payload modules 26 therefore use the user identification information to further identify modifier data associated with the user of the respective companion devices 16, 18, wherein the modifier data may include, for example, social network information, location information, time information, contact information, preference information, and so forth, that corresponds to the user. Thus, the payload module 26 of the first companion device 116 may query the modifier data sources 2.4 with the identity of the user of the first companion device 16 (e.g., “Dad”), in order to determine the social networking status, email address, and instant messaging (IM) handle of Dad. The payload module 2.6 may also determine other contextual information such as the time of day, Dad's geographic location, as well as Dad's user preferences. Similarly, the payload module 26 of the second companion device 18, may use the modifier data sources 24 to determine various contextual information that is specific to the user of the second companion device 118 (e.g., “Daughter”). The modifier data sources 24 may reside on the companion devices 16, 18, remotely on another platform, or any combination thereof

The payload modules 26 may then link the respective user-specific modifier data to the real-time keywords 20, which provide a high degree of topical relevance to the media content 14 being encountered. The real-time keywords 20 and their associated modifier data may be sent to an advertising service 30 via the communications interfaces 28, wherein the illustrated advertising service 30 includes a database 32 of advertisements that may searched and/or selected based on the information in the payload communications, In particular, the selected advertisements may be tailored to both the real-time keywords 20 and the user-specific modifier data. As a result, a first advertisement 34 may be returned to the first companion device 16, and a second advertisement 36 may be returned to the second companion device 18, wherein the illustrated advertisements 34, 36 are different and customized for the respective user.

For example, the media content 14 might be a live action sporting event with closed captioned information that reflects the unscripted remarks of the commentators, announcers and/or players, In such a scenario, one announcer may extemporaneously mention that he is having pizza for dinner, a player may mention an upcoming trip to Disneyland, and another to announcer may discuss train travel on Amtrak. Accordingly, the terms “pizza”, “Disneyland” and “Amtrak” may be extracted from the closed captioned information by the media device 12 and sent to the companion devices 16, 18 as real-time keywords 20.

The illustrated companion devices 16, 18 may then mate the real-time keywords 20 with user-specific modifier data and send the keywords 20 and related modifier data to the advertising service 30 as payload communications. In response to receiving the payload communications, the advertising service 30 may select the topical and user-specific advertisements 34, 36, and send them to the companion devices 16, 18. Thus, in the above scenario of Dad and Daughter watching a live action sporting event together, the first advertisement 34 for Dad might contain coupons for the type of pizza that Dad likes, travel deals to Disneyland and/or Amtrak fare sales. The second advertisement 36 for Daughter, on the other hand, may contain coupons for the type of pizza that Daughter likes, information regarding popular rides at Disneyland, and/or social networking friend status updates that involve train travel.

The advertisements 34, 36, may be presented to the user via the companion devices 16, 18 and/or the media device 12 concurrently with the presentation of the media content 14 to the users. Moreover, the advertisements 34, 36 may be presented to the user outside of the normal commercial break schedule associated with the media content 14. Indeed, the real-time nature of the illustrated architecture 10 enables the advertisements 34, 36 to be presented to the users nearly concurrently with (depending upon network bandwidth/speed) the occurrence of the real-time keywords 20 in the media content 14 (e.g., very shortly after the announcer mentions pizza) and potentially long before the next scheduled commercial break for the advertising inserts 22.

Moreover, one or more of the companion devices 16, 18 may be combined with the media device 12 so that one or more of the advertisements 34, 36 may be presented with the media content 14 to the user via the same device. Such a solution may be particularly advantageous for a wide variety of usage models (e.g., the user is streaming an Internet radio broadcast to a smart phone and/or smart tablet).

FIG. 2 shows a method 40 of operating a media and/or companion device. The illustrated method 40, may be implemented, for example, as a set of executable logic instructions stored in at least one machine- or computer-readable storage medium such as, for example, random access memory (RAM), read only memory (ROM), programmable ROM (PROM), flash memory, firmware, microcode, etc., in fixed-functionality hardware using circuit technology such as, for example, application specific integrated circuit (ASIC), complementary metal oxide semiconductor (CMOS) or transistor-transistor logic (FM) technology, or any combination thereof. For example, computer program code to carry out operations shown in the method 40 may be written in any combination of one or more programming languages, including, for example, an object oriented programming language such as C++ or the like and conventional procedural programming languages, such as the “C” programming language or similar programming languages. Moreover, various aspects of the illustrated functionality may be implemented as embedded logic of a processor using any of the aforementioned circuit technologies.

Illustrated processing block 42 provides for receiving one or more real-time keywords that are associated with media content. As already noted, the media content may include live programming such as sporting event programming (e.g., soccer match), news programming (e.g., network news), online programming (e.g., podcast), radio broadcast programming (e.g., morning show), etc. The media content may also be e-book (electronic book) content or other relatively static content that the user encounters. Modifier data associated with a user that encounters the media content may be identified at block 44, wherein illustrated block 46 transmits the real-time keywords and the modifier data to an advertising service. An advertisement may be received at block .48, and illustrated block 50 provides for presenting the advertisement to the user concurrently with the media content. As already noted, the media content and advertisement may be presented on the same or different devices.

FIG. 3 shows a method 52 of operating an advertising service. The illustrated method 52, may be implemented, for example, as a set of executable logic instructions stored in at least one machine- or computer-readable storage medium such as, for example, RAM, ROM, PROM, flash memory, firmware, microcode, etc., in fixed-functionality hardware using circuit technology such as, for example, ASIC, CMOS or TTL technology, or any combination thereof. Illustrated processing block 54 provides for receiving a payload communication including real-time keyword and modifier data from a device. An advertisement may be selected at block 56 based on the real-time keyword and the modifier data, wherein block 58 may transmit the selected advertisement to the device. As already noted, the real-time keyword may enable the selected advertisement to be uniquely relevant to the media content being encountered, and the modifier data may enable the selected advertisement to be of specific interest to the user encountering the media content.

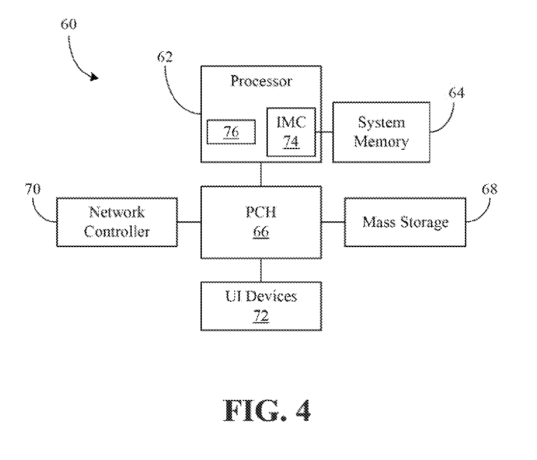

FIG. 4 shows a computing device/platform 60 having a processor 62, system memory 64, a platform controller hub (PCH) 66, mass storage (e.g., hard disk drive/HDD, optical disk, flash memory, etc.) 68, a network interface/controller 70 (e.g., communications interface), one or more user interface (UI) devices 72 and various other controllers (not shown). The platform 60 may be part of, for example, a notebook computer, PDA, wireless smart phone, media player, imaging device, MID, any smart device such as a smart phone, smart tablet, and so forth, or any combination thereof in addition, the platform 60 may be part of a smart TV, PC, server, workstation, etc. Thus, the processor 62 may include one or more processor cores capable of executing a set of stored logic instructions, and an integrated memory controller (IMC) 74 configured to communicate with the system memory 64. The system memory 64 may include, for example, dynamic random access memory (DRAM) configured as a memory module such as, for example, a dual inline memory module (DIMM), a small outline DIMM (SODIMM), etc.

In the illustrated example, the processor 62 is configured to execute logic 76 that uses the network controller 70 to receive a real-time keyword associated with media content, and identifies modifier data associated with a user that encounters the media content. The logic 76 may also use the network controller 70 to transmit the real-time keyword and the modifier data to an advertising service.

The illustrated PCH 66, sometimes referred to as a Southbridge of a chipset, functions as a host device and may communicate with the network controller 70, which could provide off platform wireless communication functionality tier a wide variety of purposes such as, for example, cellular telephone (e.g., Wideband Code Division Multiple Access/W-CDMA (Universal Mobile Telecommunications System/UMTS), CDMA2000 (IS-856/1S-2000), etc.), (Wireless Fidelity, e.g., Institute of Electrical and Electronics Engineers/IEEE 802.11-2007, Wireless Local Area Network/LAN Medium Access Control (MAC) and Physical Layer (PRY) Specifications), LR-WPAN (Low-Rate Wireless Personal Area Network, e.g., IEEE 802.15.4-2006), Bluetooth (e.g., IEEE 802.15.1-2005, Wireless Personal Area Networks), WiMax IEEE 802.16-2004, LAN/MAN Broadband Wireless LANS), GPS (Global Positioning System), spread spectrum (e.g., 900 MHz), and other RF (radio frequency) telephony purposes.

The network controller 70 may also provide off-platform wired communication (e.g., RS-232 (Electronic Industries Alliance/EIA), Ethernet (e.g., IEEE 802.3-2005), power line communication (e.g., X10, IEEE P1675), USB (e.g., Universal Serial Bus, e.g., USB Specification 3.0, Rev. 1.0, Nov. 12, 2008, USB Implementers Forum), DSL (digital subscriber line), cable modem, T1 connection, etc., functionality. The UI (e.g., touch screen, liquid crystal display/LCD, light emitting diode/LED, keyboard, mouse, etc.) devices 72 may be capable of enabling a user to interact with and perceive information from the platform 60. In particular, the UI devices 72 may be used to present advertisements and/or media content to a user of the platform 60.

Thus, techniques described herein may enable the leveraging of pre-existing closed captioned information in a unique advertising solution that determines the precise topic that is being discussed/presented to consumers. The result may be a solution that is highly scalable across different platforms (e.g., media devices, companion devices) and is very customizable to the interests, characteristics and activities of specific users.

Certain aspects of embodiments of the present invention may be implemented using hardware, software, or a combination thereof and may be implemented in one or more computer systems or other processing systems. Program code may be applied to the data entered using an input device to perform the functions described and to generate output information. The output information may be applied to one or more output devices. One of ordinary skill in the art may appreciate that embodiments may be practiced with various computer system configurations, including multiprocessor systems, minicomputers, mainframe computers, and the like. Embodiments may also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the methods described herein. Alternatively, the methods may be performed by specific hardware components that contain hardwired logic for performing the methods, or by any combination of programmed computer components and custom hardware components. The methods described herein may be provided as a computer program product that may include at least one machine readable medium having stored thereon instructions that may be used to program a processing system or other electronic device to perform the methods. The term “machine readable medium” or “machine accessible medium” used herein shall include any medium that is capable of storing or encoding a sequence of instructions for execution by the machine and that causes the machine to perform any one of the methods described herein. The terms “machine readable medium” and “machine accessible medium” may accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system to cause the processor to perform an action or produce a result.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

While various embodiments of the present invention have been described above, it should be understood that they have been presented by way of example only, and not limitation. It will be understood by those skilled in the art that various changes in form and details may he made therein without departing from the spirit and scope of the invention as defined in the appended claims. Thus, the breadth and scope of the present invention should not be limited by any of the above-described exemplary embodiments, but should be defined in accordance with the following claims and their equivalents.

We claim:

1. A computer implemented method comprising:
receiving a real-time keyword associated with media content, wherein the real-time keyword includes one or more of closed captioned information, subtitle information and dubbing information;
identifying a user that encounters the media content based on one or more of login information, device information, web service selection information, and the media content;
identifying modifier data associated with the user, wherein the modifier data includes one or more of social network information, location information, time information, contact information, and preference information;
transmitting the real-time keyword and the modifier data to an advertising service; and
receiving an advertisement from the advertising service.

2. The method of claim 1, further including presenting the advertisement to the user via a first device concurrently with a presentation of the media content to the user via a second device, wherein presentation of the advertisement to the user occurs outside a commercial break schedule associated with the media content.

3. The method of claim 1, further including:
presenting the media content to the user; and
presenting the advertisement to the user concurrently with the media content, wherein presentation of the advertisement to the user occurs outside a commercial break schedule associated with the media content.

4. The method of claim I, wherein the media content includes live programming.

5. The method of claim 4, wherein the live programming includes one or more of sporting event programming, news programming, online programming and radio broadcast programming.

6. At least one computer accessible storage medium comprising a set of instructions which, if executed by a processor, cause a computer to:
receive a real-time keyword associated with media content;
identify modifier data associated with a user that encounters the media content; and
transmit the real-time keyword and the modifier data to an advertising service.

7. The medium of claim 6, wherein the instructions, if executed, cause a computer to receive an advertisement from the advertising service.

8. The medium of claim 7, wherein the instructions, if executed, cause a computer to present the advertisement to the user via a first device concurrently with a presentation of the media content to the user via a second device, wherein presentation of the advertisement to the user is to occur outside a commercial break schedule associated with the media content.

9. The medium of claim 7, wherein the instructions, if executed, cause a computer to:
present the media content to the user; and
present the advertisement to the user concurrently with the media content, wherein presentation of the advertisement is to occur outside a commercial break schedule associated with the media content.

10. The medium of claim 6, wherein the instructions, if executed, cause a computer to identify the user based on one or more of login information, device information, web service selection information, and the media content.

11. The medium of claim 6, wherein the modifier data is to include one or more of social network information, location information, time information, contact information, and preference information.

12. The medium of claim 6, wherein the real-time keyword is to include one or more of closed captioned information, subtitle information and dubbing information.

13. The medium of claim 6, wherein the media content is to include live Programming.

14. The medium of claim 13, wherein the live programming is to include one or more of sporting event programming, news programming, online programming and radio broadcast programming.

15. A device comprising:
a payload module to identify modifier data associated with a user that encounters media content; and
a communications interface to receive a real-time keyword associated with the media content, and transmit the real-time keyword and the modifier data to an advertising service.

16. The device of claim 15, wherein the communications interface is to receive an advertisement from the advertising service.

17. The device of claim 16, further including a user interface (UI) to present the advertisement to the user concurrently with a presentation of the media content to the user via a remote device, wherein presentation of the advertisement to the user is to occur outside a commercial break schedule associated with the media content.

18. The device of claim 16, further including a user interface (UI) to present the media content to the user, and present the advertisement to the user concurrently with the media content, wherein presentation of the advertisement is to occur outside a commercial break schedule associated with the media content.

19. The device of claim 15, further including an identification module to identify the user based on one or more of login information, device information, web service selection information, and the media content.

20. The device of claim 15, wherein the modifier data is to include one or more of social network information, location information, time information, contact information, and preference information.

21. The device of claim 15, wherein the media content is to include live programming.

22. The device of claim 21, wherein the live programming is to include one or more of sporting event programming, news programming, online programming and radio broadcast programming.

23. At least one computer readable storage medium comprising a set of instructions which, if executed by a processor, cause a computer to:
receive a payload communication from a device, wherein the payload communication is to include a real-time keyword associated with media content, and modifier data associated with a user that encounters the media content;
select an advertisement based on the real-time keyword and the modifier data; and
transmit the advertisement to the device.

24. The medium of claim 23, wherein the advertisement is to be transmitted to the device during presentation of the media content to the user.

25. The medium of claim 23, wherein the modifier data is to include one or more of social network information, location information, time information, contact information, and preference information.

26. The medium of claim 23, wherein the real-time keyword is to include one or more of closed captioned information, subtitle information and dubbing information.

27. The medium of claim 23, wherein the media content is o include live programming.

28. The medium of claim 27, wherein the live programming is to include one or more of sporting event programming, news programming, online programming and radio broadcast programming.
